(19) United States
(12) Patent Application Publication
(10) Pub. No.: US 2021/0348772 A1
(43) Pub. Date: Nov. 11, 2021

(54) MULTI-SEGMENT NOZZLE AND COOKING OVEN

(71) Applicant: TEAM YOUNG TECHNOLOGY CO., LTD., Taoyuan City (TW)

(72) Inventor: Pin-Chun Huang, Taoyuan City (TW)

(73) Assignee: TEAM YOUNG TECHNOLOGY CO., LTD., Taoyuan City (TW)

(21) Appl. No.: 17/199,457

(22) Filed: Mar. 12, 2021

(30) Foreign Application Priority Data
May 8, 2020 (TW) 109115450

(51) Int. Cl. F24C 15/32

(52) U.S. Cl. CPC F24C 15/322

(57) ABSTRACT

A multi-segment nozzle and a cooking oven are provided. The multi-segment nozzle includes a first nozzle segment, having a first air inlet and a first opening and an inner diameter gradually decreasing from the first air inlet to the first opening; a second nozzle segment, having a second air inlet and a second opening and an inner diameter gradually decreasing from the second air inlet to the second opening; a base section, having a third air inlet and a third opening; a first rotating shaft assembly, pivotally connected at a junction of the first air inlet and the third opening; and a second rotating shaft assembly, pivotally connected at a junction of the second air inlet and the first opening. Initially, at least one of the first and second nozzle segments is arranged at an oblique angle relative to the wind direction of the base section.

### CROSS-REFERENCE TO RELATED APPLICATION

This application claims the priority benefit of Taiwan application serial no. 109115450, filed on May 8, 2020. The entirety of the above-mentioned patent application is hereby incorporated by reference herein and made a part of this specification.

### BACKGROUND

### Technical Field

The disclosure relates to a nozzle, and more particularly to a multi-segment nozzle and a cooking oven.

### Description of Related Art

Existing ovens generally use convection and radiation to heat food. However, when most existing cooking products are roasting meat, the moisture on the surface of the food cannot be effectively removed, so no matter how fast the convective heat conduction of the heating medium is, part of the heat must be supplied to evaporate the moisture on the surface of the food, which causes the surface temperature of the food to not rise fast enough (the temperature difference between the inside and outside of the food is reduced). Especially when the center temperature of the meat exceeds 40° C., a large amount of liquid will overflow from the surface due to muscle protein contraction, so more energy and time are required for the surface temperature of the meat to achieve the ideal Maillard reaction ideal temperature (>120° C.). In addition, steam evaporated from the moisture will envelope the surface of the meat, and the radiation wavelength of a black iron heating tube overlaps with the absorption wavelength of the steam, which causes low radiant heating efficiency. As such, the surface of the meat is prone to contain water and is difficult to be crispy, or the inside of the meat is overcooked in order for the surface of the meat to be crispy.

In order to improve the above shortcomings, the existing oven adopts the technology of simple high-speed impact convection (>22.35 m/s) or microwave function combination. However, even the smallest oven with a capacity of 10 liters consumes 3000 W of electricity, which is difficult for ordinary households to cope with the huge electricity consumption. The so-called high-speed impact convection is achieved by a high-pressure blower and a porous disk array nozzle. The main shortcoming is that the flow field of each nozzle hole is difficult to be uniform, which is a great issue when adjusting the wind speed. In addition, the porous nozzle disk will cause pressure loss. Therefore, in order to achieve the declared air volume and wind speed, the performance of the high-pressure blower must be improved. As a result, the amount of electricity consumption is prone to exceed the amount that ordinary households can cope, which is difficult to benefit ordinary households.

In addition, the design of general integrated flexible nozzle on the market has a small pipe diameter, so high pressure is required for usage. If the radius of the flow channel is designed to be greater than the thickness of the pipe wall, bending the flow channel may deform the cross-sectional area of the pipe, just like bending a silicone straw. When the angle is too large, the cross-sectional area of the pipe may even be reduced, which seriously affects the pressure loss of the fluid and causes the flow speed to be poor.

The other type of impact nozzle is fixed, so the roasted substance must rely on the help of a tracklayer to achieve a uniform effect, which is difficult to be implemented in general ovens.

### SUMMARY

The main objective of the disclosure is to provide a multi-segment nozzle with one end connected to an airflow outlet in a chamber and including the following. A first nozzle segment is a hollow shell. Two sides of the hollow shell respectively have a first air inlet and a first opening communicated with the inside of the hollow shell. The inner diameter of the hollow shell gradually decreases from the first air inlet to the first opening. A second nozzle segment is a hollow shell. Two sides of the hollow shell respectively have a second air inlet and a second opening communicated with the inside of the hollow shell. The inner diameter of the hollow shell gradually decreases from the second air inlet to the second opening. The inner diameter of the second air inlet of the second nozzle segment is greater than the inner diameter of the first opening of the first nozzle segment. A base section is a hollow shell. Two sides of the hollow shell respectively have a third air inlet and a third opening communicated with the inside of the hollow shell. The third air inlet of the base section is communicated with the airflow outlet. A first rotating shaft assembly is pivotally connected at a junction of the first air inlet of the first nozzle segment and the third opening of the base section, so that the first nozzle segment may swing. A second rotating shaft assembly is pivotally connected at a junction of the second air inlet of the second nozzle segment and the first opening of the first nozzle segment, so that the second nozzle segment may swing.

Moreover, in order to achieve the above objective, in the multi-segment nozzle of the disclosure, initially, when the second nozzle segment yaws clockwise according to the second rotating shaft assembly, the first nozzle segment is driven by the second nozzle segment to yaw counterclockwise according to the first rotating shaft assembly. When the first nozzle segment is changed to yawing clockwise by wind pressure, the second nozzle segment yaws counterclockwise according to the second rotating shaft assembly. After continuous operation, due to the simultaneous action of wind pressure and swing inertia, the first nozzle segment and the second nozzle segment yaw in the same direction.

In addition, in order to achieve the above objective, the multi-segment nozzle of the disclosure further includes at least one limiting ring. The limiting ring is sleeved to an adjoiner of the third opening of the base section or the limiting ring is sleeved to an adjoiner of the first opening of the first nozzle segment.

In addition, in order to achieve the above objective, the multi-segment nozzle of the disclosure further includes a limiting mechanism for accommodating at least one of the first nozzle segment and the second nozzle segment. The limiting mechanism also has at least one pair of a first limiting member and a second limiting member. The first limiting member and the second limiting member are relatively disposed on two sides of at least one of the first nozzle segment and the second nozzle segment. When the first limiting member and the second limiting member moves outward or inward according to the perpendicular wind direction of the base section, swing amplitudes or frequencies of the first nozzle segment and the second nozzle segment are adjusted.

Moreover, in order to achieve the above objective, in the multi-segment nozzle of the disclosure, initially, at least one of the first nozzle segment and the second nozzle segment is arranged at an oblique angle with respect to the wind direction of the base section. Wind pressure generated by the airflow outlet is brought to the second nozzle segment via the first nozzle segment. By the action of wind pressure and swing inertia, the first nozzle segment and the second nozzle segment respectively generate a periodic swing with respect to the first rotating shaft assembly and the second rotating shaft assembly.

Another main objective of the disclosure is to provide a multi-segment nozzle, which is connected with an airflow outlet in a chamber and includes the following. A first nozzle segment is a hollow shell. Two sides of the hollow shell respectively have a first air inlet and a first opening communicated with the inside of the hollow shell. The inner diameter of the hollow shell gradually decreases from the first air inlet to the first opening. There are M second nozzle segments, where M is a positive integer greater than or equal to 2. Each second nozzle segment is a hollow shell. Two sides of the hollow shell respectively have a second air inlet and a second opening communicated with the inside of the hollow shell. The inner diameter of the hollow shell gradually decreases from the second air inlet to the second opening. The inner diameter of the second air inlet of the second nozzle segment is greater than the inner diameter of the first opening of the first nozzle segment. A base section is a hollow shell. Two sides of the hollow shell respectively have a third air inlet and a third opening communicated with the inside of the hollow shell. The third air inlet of the base section is communicated with the airflow outlet. A first rotating shaft assembly is pivotally connected at a junction of the first air inlet of the first nozzle segment and the third opening of the base section, so that the first nozzle segment may swing. There are M second rotating shaft assemblies, where M is a positive integer greater than or equal to 2, corresponding one-to-one to the M second nozzle segments. The M second nozzle segments are serially connected back and forth in sequence by the M second rotating shaft assemblies. The first second rotating shaft assembly is pivotally connected at a junction disposed at the second air inlet of the corresponding second nozzle segment positioned first and the first opening of the first nozzle segment, and each of the remaining second rotating shaft assemblies is pivotally connected at a junction of the second opening of the second nozzle segment positioned in front and the second air inlet of the second nozzle segment positioned behind, so that each second nozzle segment may swing.

In addition, in order to achieve the above objective, in the multi-segment nozzle of the disclosure, the first rotating shaft assembly includes two rotating shafts parallel to each other, and the second rotating shaft assembly includes two rotating shafts parallel to each other.

In addition, in order to achieve the above objective, the multi-segment nozzle of the disclosure further includes at least one limiting ring. The limiting ring is sleeved to an adjoiner of the third opening of the base section, the limiting ring is sleeved to an adjoiner of the first opening of the first nozzle segment, or the limiting ring is sleeved to an adjoiner of the second opening of the at least one second nozzle segment of the M second nozzle segments.

In addition, in order to achieve the above objective, the multi-segment nozzle of the disclosure further includes a limiting mechanism for accommodating at least one of the first nozzle segment and the at least one second nozzle segment. The limiting mechanism includes at least one pair of a first limiting member and a second limiting member. The first limiting member and the second limiting member are relatively disposed on two sides of at least one of the first nozzle segment and the at least one second nozzle segment. When the first limiting member and the second limiting member moves outward or inward according to the wind perpendicular direction of the base section, swing amplitudes or frequencies of the first nozzle segment and the at least one second nozzle segment are adjusted.

In addition, in order to achieve the above objective, the multi-segment nozzle of the disclosure further includes a rotating mechanism connected to the base section. When the rotating mechanism is driven to rotate, the base section rotates according to the wind direction of the base section.

Moreover, in order to achieve the above objective, in the multi-segment nozzle of the disclosure, initially, when the second nozzle segment positioned first yaws clockwise according to the second rotating shaft assembly, the first nozzle segment is driven by the second nozzle segment positioned first to yaw counterclockwise according to the first rotating shaft assembly. When the first nozzle segment is changed to yawing clockwise by wind pressure, the second nozzle segment positioned first is changed to yawing counterclockwise according to the second rotating shaft assembly. When any one of the remaining second nozzle segments yaws clockwise according to the second rotating shaft assembly, the second nozzle segment positioned in front is driven by the second nozzle segment to be changed to yawing counterclockwise according to the second rotating shaft assembly corresponding to the second nozzle segment positioned in front. When the second nozzle segment positioned in front is changed to yawing clockwise by wind pressure according to the second rotating shaft assembly, the second nozzle segment is changed to yawing counterclockwise according to the corresponding second rotating shaft assembly. After continuous operation, due to the simultaneous action of wind pressure and swing inertia, the first nozzle segment and the second nozzle segment yaw in the same direction.

Moreover, in order to achieve the above objective, in the multi-segment nozzle of the disclosure, initially, at least one of the first nozzle segment and the M second nozzle segments is arranged at an oblique angle with respect to the wind direction of the base section. Wind pressure generated by the airflow outlet is brought to the M second nozzle segments via the first nozzle segment. By the action of wind pressure and swing inertia, the first nozzle segment and the M second nozzle segments respectively generate a periodic swing with respect to the first rotating shaft assembly and the M second rotating shaft assemblies. The greater the value of M, the greater the swing amplitudes of the first nozzle segment and the M second nozzle segments.

Another main objective of the disclosure is to provide a cooking oven including the following. A chamber is configured to accommodate a food. A hot wind module includes a heat generating element and a wind speed generating element. One end of a multi-segment nozzle is connected with an airflow outlet in the chamber. The multi-segment nozzle includes the following. A first nozzle segment is a hollow shell. Two sides of the hollow shell respectively have a first air inlet and a first opening communicated with the inside of the hollow shell. The inner diameter of the hollow shell gradually decreases from the first air inlet to the first opening. A second nozzle segment is a hollow shell. Two sides of the hollow shell respectively have a second air inlet and a second opening communicated with the inside of the hollow shell. The inner diameter of the hollow shell gradually decreases from the second air inlet to the second opening. The inner diameter of the second air inlet of the second nozzle segment is greater than the inner diameter of the first opening of the first nozzle segment. A base section is a hollow shell. Two sides of the hollow shell respectively have a third air inlet and a third opening communicated with the inside of the hollow shell. The third air inlet of the base section is communicated with the airflow outlet. A first rotating shaft assembly is pivotally connected at a junction of the first air inlet of the first nozzle segment and the third opening of the base section, so that the first nozzle segment may swing. A second rotating shaft assembly is pivotally connected at a junction of the second air inlet of the second nozzle segment and the first opening of the first nozzle segment, so that the second nozzle segment may swing. The multi-segment nozzle is disposed on the top surface in the chamber. Heat energy provided by the heat generating element generates wind pressure of airflow via the wind speed generating element and is output to the airflow outlet, and is brought to the second nozzle segment via the base section and the first nozzle segment of the multi-segment nozzle. By swing inertia of the first rotating shaft assembly of the first nozzle segment and the second rotating shaft assembly of the second nozzle segment, a periodically swinging jet airflow is generated in the chamber. The multi-segment nozzle continuously impacts the jet airflow onto the food.

Another main objective of the disclosure is to provide a cooking oven including the following. A chamber is configured to accommodate a food. A hot wind module includes a heat generating element and a wind speed generating element. One end of a multi-segment nozzle is connected with an airflow outlet in the chamber. The multi-segment nozzle includes the following. A first nozzle segment is a hollow shell. Two sides of the hollow shell respectively have a first air inlet and a first opening communicated with the inside of the hollow shell. The inner diameter of the hollow shell gradually decreases from the first air inlet to the first opening. There are M second nozzle segments, where M is a positive integer greater than or equal to 2. Each second nozzle segment is a hollow shell. Two sides of the hollow shell respectively have a second air inlet and a second opening communicated with the inside of the hollow shell. The inner diameter of the hollow shell gradually decreases from the second air inlet to the second opening. The inner diameter of the second air inlet of the second nozzle segment is greater than the inner diameter of the first opening of the first nozzle segment. A base section is a hollow shell. Two sides of the hollow shell respectively have a third air inlet and a third opening communicated with the inside of the hollow shell. The third air inlet of the base section is communicated with the airflow outlet. A first rotating shaft assembly is pivotally connected at a junction of the first air inlet of the first nozzle segment and the third opening of the base section, so that the first nozzle segment may swing. There are M second rotating shaft assemblies, where M is a positive integer greater than or equal to 2, corresponding one-to-one to the M second nozzle segments. The M second nozzle segments are serially connected back and forth in sequence by the M second rotating shaft assemblies. The first second rotating shaft assembly is pivotally connected at a junction disposed at the second air inlet of the corresponding second nozzle segment positioned first and the first opening of the first nozzle segment, and each of the remaining second rotating shaft assemblies is pivotally connected at a junction of the second opening of the second nozzle segment positioned in front and the second air inlet of the second nozzle segment positioned behind, so that each second nozzle segment may swing. The multi-segment nozzle is disposed on the top surface in the chamber. Heat energy provided by the heat generating element generates wind pressure of airflow via the wind speed generating element and is output to the airflow outlet, and is brought to the second nozzle segment via the base section and the first nozzle segment of the multi-segment nozzle. By swing inertia of the first rotating shaft assembly of the first nozzle segment and the second rotating shaft assembly of the second nozzle segment, a periodically swinging jet airflow is generated in the chamber. The multi-segment nozzle continuously impacts the jet airflow onto the food.

In addition, in order to achieve the above objective, the cooking oven of the disclosure further includes a rotating mechanism connected to the base section. When the rotating mechanism is driven to rotate, the base section rotates according to the wind direction of the base section.

With the multi-segment nozzle provided by the disclosure, the single nozzle airflow outlet is used to reduce the pressure drop caused by the porous nozzle disk in the prior art. At the same time, the multi-segment nozzle of the disclosure uses wind pressure to swing naturally. The swing amplitude may be controlled by the limiting mechanism. The maximum swing angle may also be controlled by the number of the second nozzle segment. Therefore, the spraying range is easy to control and the operation of additional mechanisms is reduced. Also, the multi-segment nozzle rotates the wind direction of the base section via the rotating mechanism, so the rotational angle, direction, and speed of the multi-segment nozzle may be effectively controlled.

The disclosure provides a cooking oven. The heat energy provided by the heat generating element generates airflow via the wind speed generating element and is output to the airflow outlet. By swing inertia of the multi-segment nozzle the jet airflow is generated in the chamber, so as to produce a uniform flow field. The multi-segment nozzle continuously impacts the jet airflow onto the food, and quickly separates the food surface from the liquid substance seeped therefrom, so that the food surface maintains a nearly dry state. The temperature can be quickly raised to achieve the Maillard reaction temperature, so that the food surface presents a crispy appearance, so that the cooking oven of the disclosure can better satisfy general user requirements.

The detailed structures, characteristics, assembly, or usage steps of the multi-segment nozzle and the cooking oven provided by the disclosure will be described in the detail in the subsequent embodiments. However, persons skilled in the art should be able to understand that the detailed descriptions and specific embodiments for implementing the disclosure are only used to illustrate the disclosure, and are not intended to limit the scope of the claims of the disclosure.

### BRIEF DESCRIPTION OF THE DRAWINGS

FIG. 1 is a three-dimensional exploded view of a multi-segment nozzle according to a first embodiment of the disclosure.

FIG. 2 is a three-dimensional combined view of the multi-segment nozzle according to the first embodiment of the disclosure.

FIG. 3 is a schematic cross-sectional view of a side view of a structure of the multi-segment nozzle according to the first embodiment of the disclosure.

FIG. 4 is a schematic cross-sectional view of a structure of another multi-segment nozzle according to the first embodiment of the disclosure.

FIG. 5 is a three-dimensional combined view of another multi-segment nozzle according to the first embodiment of the disclosure.

FIG. 6 is a schematic view of a cooking oven according to a third embodiment of the disclosure.

### DETAILED DESCRIPTION OF DISCLOSED EMBODIMENTS

Hereinafter, the corresponding preferred embodiments are listed in conjunction with the drawings to describe the components, steps, and achieved effects of a multi-segment nozzle 100 and a cooking oven 200 of the disclosure. However, the components, sizes, and appearances of the multi-segment nozzle 100 and the cooking oven 200 in the drawings are only used to illustrate the technical features of the disclosure, but not to limit the disclosure.

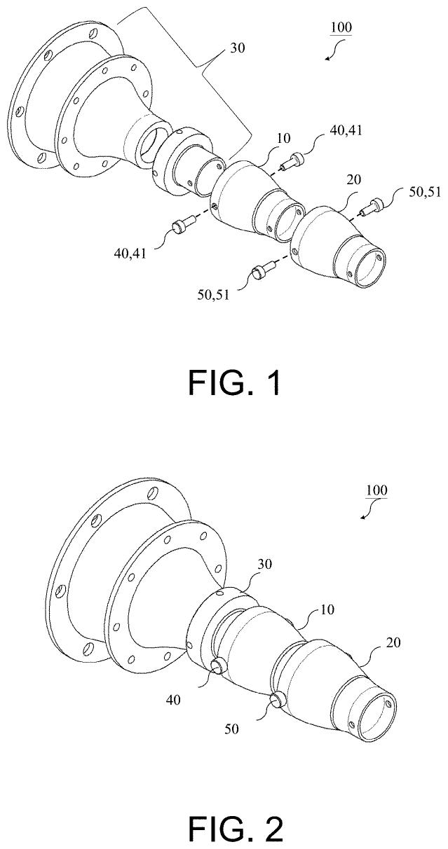

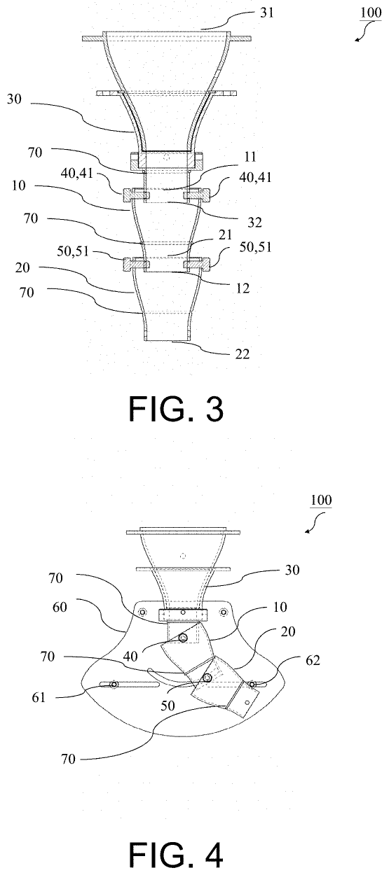

Referring to a first embodiment shown in FIG. 1, FIG. 2, FIG. 3, and FIG. 6, the multi-segment nozzle 100 of the disclosure has one end connected to an airflow outlet 211 in a chamber 210 and includes the following. A first nozzle segment 10 is a hollow shell. Two sides of the hollow shell respectively have a first air inlet 11 and a first opening 12 communicated with the inside of the hollow shell. The inner diameter of the hollow shell gradually decreases from the first air inlet 11 to the first opening 12. A second nozzle segment 20 is a hollow shell. Two sides of the hollow shell respectively have a second air inlet 21 and a second opening 22 communicated with the inside of the hollow shell. The inner diameter of the hollow shell gradually decreases from the second air inlet 21 to the second opening 22. The inner diameter of the second air inlet 21 of the second nozzle segment 20 is greater than the inner diameter of the first opening 12 of the first nozzle segment 10. A base section 30 is a hollow shell. Two sides of the hollow shell respectively have a third air inlet 31 and a third opening 32 communicated with the inside of the hollow shell. The third air inlet 31 of the base section 30 is communicated with the airflow outlet 211. A first rotating shaft assembly 40 is pivotally connected at a junction of the first air inlet 11 of the first nozzle segment 10 and the third opening 32 of the base section 30, so that the first nozzle segment 10 may swing. A second rotating shaft assembly 50 is pivotally connected at a junction of the second air inlet 21 of the second nozzle segment 20 and the first opening 12 of the first nozzle segment 10, so that the second nozzle segment 20 may swing. Initially, at least one of the first nozzle segment 10 and the second nozzle segment 20 is arranged at an oblique angle with respect to the wind direction of the base section 30. Wind pressure generated by the airflow outlet 211 is brought to the second nozzle segment 20 via the first nozzle segment 10. By the action of wind pressure and swing inertia, the first nozzle segment 10 and the second nozzle segment 20 respectively generate a periodic swing with respect to the first rotating shaft assembly 40 and the second rotating shaft assembly 50.

The materials of the first nozzle segment 10 and the second nozzle segment 20 are mainly lightweight metal thin shell, heat-resistant silicon, or a combination of the two in order to reduce the required wind pressure for swinging and facilitate assembly. The linking members of the first rotating shaft assembly 40 of the first nozzle segment 10 and the second rotating shaft assembly 50 of the second nozzle segment 20 are mainly smooth metal members in order to reduce rotational friction.

At the same time, continue to refer to the first embodiment shown in FIG. 1, FIG. 2, and FIG. 3. In this embodiment, initially, when the second nozzle segment 20 of the multi-segment nozzle 100 of the disclosure yaws clockwise according to the second rotating shaft assembly 50, the first nozzle segment 10 is driven by the second nozzle segment 20 to yaw counterclockwise according to the first rotating shaft assembly 40. When the first nozzle segment 10 is changed to yawing clockwise by wind pressure, the second nozzle segment 20 is changed to yawing counterclockwise according to the second rotating shaft assembly 50. After continuous operation, due to the simultaneous action of wind pressure and swing inertia, the first nozzle segment 10 and the second nozzle segment 20 yaw in the same direction. When the first rotating shaft assembly 40 is fixed in any form, the multi-segment nozzle 100 can stop swinging. For example, when the first rotating shaft assembly 40 fixes the first air inlet 11 of the first nozzle segment 10 and the third opening 32 of the base section 30, the first nozzle segment 10 and the second nozzle segment 20 stop swinging.

At the same time, continue to refer to the first embodiment shown in FIG. 1, FIG. 2, and FIG. 3. In this embodiment, the first rotating shaft assembly 40 of the multi-segment nozzle 100 of the disclosure includes two rotating shafts 41 that are penetrated between the first air inlet 11 of the first nozzle segment 10 and the third opening 32 of the base section 30 and are parallel to each other. The second rotating shaft assembly 50 includes two rotating shafts 51 that are penetrated between the second air inlet 21 of the second nozzle segment 20 and the first opening 12 of the first nozzle segment 10 and are parallel to each other.

At the same time, continue to refer to the first embodiment shown in FIG. 1, FIG. 2, FIG. 3, and FIG. 4. FIG. 4 shows that the multi-segment nozzle 100 according to the first embodiment of the disclosure further includes at least one limiting ring 70. The limiting ring 70 may be sleeved to an adjoiner of the third opening 32 of the base section 30. When the limiting ring 70 moves forward (not shown) according to the wind direction of the base section 30, the swing amplitude of the first nozzle segment 10 is increased. When the limiting ring 70 moves backward (not shown) according to the wind direction of the base section 30, the swing amplitude of the first nozzle segment 10 is reduced. The edge of the first air inlet 11 of the first nozzle segment 10 hitting the limiting ring 70 sleeved to the base section 30 is defined as the maximum swing amplitude of the first nozzle segment 10. At the same time, the limiting ring 70 may prevent the edge of the first air inlet 11 of the first nozzle segment 10 from hitting the base section 30. The limiting ring 70 may be sleeved to an adjoiner of the first opening 12 of the first nozzle segment 10. When the limiting ring 70 moves forward (not shown) according to the wind direction of the base section 30, the swing amplitude of the second nozzle segment 20 is increased. When the limiting ring 70 moves backward (not shown) according to the wind direction of the base section 30, the swing amplitude of the second nozzle segment 20 is reduced. The edge of the second air inlet 21 of the second nozzle segment 20 hitting the limiting ring 70 sleeved to the first nozzle segment 10 is defined as the maximum swing amplitude of the second nozzle segment 20. At the same time, the limiting ring 70 may prevent the edge of the second air inlet 21 of the second nozzle segment 20 from hitting the first nozzle segment 10. The material of the limiting ring 70 is mainly heat-resistant silicone in order to reduce material wear and increase rebound swing force.

At the same time, continue to refer to the first embodiment shown in FIG. 1, FIG. 2, FIG. 3, and FIG. 4. FIG. 4 shows that the multi-segment nozzle 100 according to the first embodiment of the disclosure further includes a limiting mechanism 60 for accommodating at least one of the first nozzle segment 10 and the second nozzle segment 20. The limiting mechanism 60 includes at least one pair of a first limiting member 61 and a second limiting member 62. The first limiting member 61 and the second limiting member 62 are relatively disposed on two sides of at least one of the first nozzle segment 10 and the second nozzle segment 20. When the first limiting member 61 and the second limiting member 62 move outward according to the perpendicular wind direction of the base section 30, the swing amplitudes of the first nozzle segment 10 and the second nozzle segment 20 are adjusted to be increased and the swing frequencies thereof are slower. When the first limiting member 61 and the second limiting member 62 move inward according to the perpendicular wind direction of the base section 30, the swing amplitudes of the first nozzle segment 10 and the second nozzle segment 20 are adjusted to be reduced and the swing frequencies thereof are faster. The edge of the first air inlet 11 of the first nozzle segment 10 hitting the limiting ring 70 sleeved to the base section 30 is defined as the maximum swing amplitude of the first nozzle segment 10. The edge of the second air inlet 21 of the second nozzle segment 20 hitting the limiting ring 70 sleeved to the first nozzle segment 10 is defined as the maximum swing amplitude of the second nozzle segment 20. When the first limiting member 61 and the second limiting member 62 move forward (not shown) according to the wind direction of the base section 30, the swing frequencies of the first nozzle segment 10 and the second nozzle segment 20 are slower. When the first limiting member 61 and the second limiting member 62 move backward (not shown) according to the wind direction of the base section 30, the swing frequencies of the first nozzle segment 10 and the second nozzle segment 20 are faster. The materials of the first limiting member 61 and the second limiting member 62 are mainly heat-resistant silicone in order to reduce material wear and increase rebound swing force. The limiting mechanism 60 may manually or automatically change the movement positions of the first limiting member 61 and the second limiting member 62.

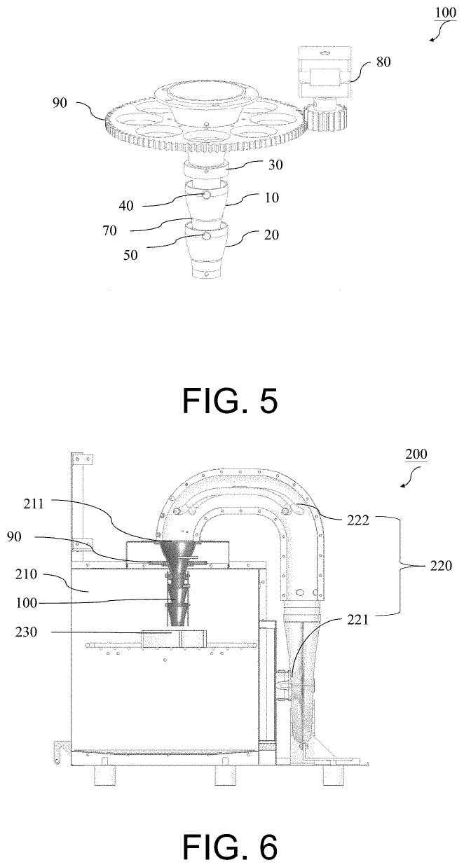

At the same time, continue to refer to the first embodiment shown in FIG. 1, FIG. 2, FIG. 3, and FIG. 5. FIG. 5 shows that the multi-segment nozzle 100 according to the first embodiment of the disclosure further includes a rotating mechanism 90. The rotating mechanism 90 is, for example, a rotating gear set. The rotating mechanism 90 is connected to the base section 30. The rotating mechanism 90 may be manually or automatically rotated, so that the base section 30 rotates according to the wind direction of the base section 30, which may effectively control the rotational angle, direction, and speed. The multi-segment nozzle 100 further includes a rotating device 80. The rotating device 80 may be, for example, a motor that provides rotational power to drive the rotating gear set to rotate. However, the rotating driving method of the disclosure is not limited to the use of the motor and the rotating gear set. The rotating mechanism 90 may be, for example, a rotating gear set, a chain set, or a heat-resistant pulley set. The heat-resistant pulley set is preferred for vibrational noise reduction.

A second embodiment (not shown) of the disclosure is similar to the multi-segment nozzle 100 described in the first embodiment. With reference to FIG. 1, FIG. 2, FIG. 3, and FIG. 6, the differences are that there are multiple second nozzle segments 20 and multiple second rotating shaft assemblies 50 of the multi-segment nozzle 100 of the disclosure. One end of the multi-segment nozzle 100 of the disclosure is connected with an airflow outlet 211 in a chamber 210. The multi-segment nozzle 100 includes the following. A first nozzle segment 10 is a hollow shell. Two sides of the hollow shell respectively have a first air inlet 11 and a first opening 12 communicated with the inside of the hollow shell. The inner diameter of the hollow shell gradually decreases from the first air inlet 11 to the first opening 12. There are M second nozzle segments 20, where M is a positive integer greater than or equal to 2. Each second nozzle segment 20 is a hollow shell. Two sides of the hollow shell respectively have a second air inlet 21 and a second opening 22 communicated with the inside of the hollow shell. The inner diameter of the hollow shell gradually decreases from the second air inlet 21 to the second opening 22. The inner diameter of the second air inlet 21 of the second nozzle segment 20 is greater than the inner diameter of the first opening 12 of the first nozzle segment 10. A base section 30 is a hollow shell. Two sides of the hollow shell respectively have a third air inlet 31 and a third opening 32 communicated with the inside of the hollow shell. The third air inlet 31 of the base section 30 is communicated with the airflow outlet 211. A first rotating shaft assembly 40 is pivotally connected at a junction of the first air inlet 11 of the first nozzle segment 10 and the third opening 32 of the base section 30, so that the first nozzle segment 10 may swing. There are M second rotating shaft assemblies 50, where M is a positive integer greater than or equal to 2, corresponding one-to-one to the M second nozzle segments 20. The M second nozzle segments 20 are serially connected back and forth in sequence by the M second rotating shaft assemblies 50. The first second rotating shaft assembly 50 is pivotally connected at a junction disposed at the second air inlet 21 of the corresponding second nozzle segment 20 positioned first and the first opening 12 of the first nozzle segment 10, and each of the remaining second rotating shaft assemblies 50 is pivotally connected at a junction of the second opening 22 of the second nozzle segment 20 positioned in front and the second air inlet 21 of the second nozzle segment 20 positioned behind, so that each second nozzle segment 20 may swing. Initially, at least one of the first nozzle segment 10 and the M second nozzle segments 20 is arranged at an oblique angle with respect to the wind direction of the base section 30. Wind pressure generated by the airflow outlet 211 is brought to the M second nozzle segments 20 via the first nozzle segment 10. By the action of wind pressure and swing inertia, the first nozzle segment 10 and the M second nozzle segments 20 respectively generate a periodic swing with respect to the first rotating shaft assembly 40 and the M second rotating shaft assemblies 50. The greater the value of M, the greater the swing amplitudes of the first nozzle segment 10 and the M second nozzle segments 20.

In the second embodiment, in the multi-segment nozzle 100 of the disclosure, initially, when the second nozzle segment 20 positioned first yaws clockwise according to the second rotating shaft assembly 50, the first nozzle segment 10 is driven by the second nozzle segment 20 positioned first to yaw counterclockwise according to the first rotating shaft assembly 40. When the first nozzle segment 10 is changed to yawing clockwise by wind pressure, the second nozzle segment 20 positioned first is changed to yawing counterclockwise according to the second rotating shaft assembly 50. When any one of the remaining second nozzle segments 20 yaws clockwise according to the second rotating shaft assembly 50, the second nozzle segment 20 positioned in front is driven by the second nozzle segment 20 to be changed to yawing counterclockwise according to the second rotating shaft assembly 50 corresponding to the second nozzle segment 20 positioned in front. When the second nozzle segment 20 positioned in front is changed to yawing clockwise by wind pressure according to the second rotating shaft assembly 50, the second nozzle segment 20 is changed to yawing counterclockwise according to the corresponding second rotating shaft assembly 50. After continuous operation, due to the simultaneous action of wind pressure and swing inertia, the first nozzle segment 10 and the second nozzle segment 20 yaw in the same direction.

In the second embodiment, the first rotating shaft assembly 40 of the multi-segment nozzle 100 of the disclosure includes two rotating shafts 41 that are penetrated between the first air inlet 11 of the first nozzle segment 10 and the third opening 32 of the base section 30 and are parallel to each other. The first second rotating shaft assembly 50 includes two rotating shafts 51 that are penetrated between the second air inlet 21 of the first second nozzle segment 20 positioned first and the first opening 12 of the first nozzle segment 10 and are parallel to each other. Any one of the remaining second rotating shaft assemblies 50 includes the two rotating shafts 51 that are penetrated between the second air inlet 21 of the second nozzle segment 20 positioned in front and the second opening 22 of the second nozzle segment 20 and are parallel to each other.

In the second embodiment, the multi-segment nozzle 100 of the disclosure further includes at least one limiting ring 70. The limiting ring 70 may be sleeved to an adjoiner of the third opening 32 of the base section 30. When the limiting ring 70 moves forward (not shown) according to the wind direction of the base section 30, the swing amplitude of the first nozzle segment 10 is increased. When the limiting ring 70 moves backward (not shown) according to the wind direction of the base section 30, the swing amplitude of the first nozzle segment 10 is reduced. The edge of the first air inlet 11 of the first nozzle segment 10 hitting the limiting ring 70 sleeved to the base section 30 is defined as the maximum swing amplitude of the first nozzle segment 10. At the same time, the limiting ring 70 may prevent the edge of the first air inlet 11 of the first nozzle segment 10 from hitting the base section 30. The limiting ring 70 may be sleeved to an adjoiner of the first opening 12 of the first nozzle segment 10. When the limiting ring 70 moves forward (not shown) according to the wind direction of the base section 30, the swing amplitude of the second nozzle segment 20 is increased. When the limiting ring 70 moves backward (not shown) according to the wind direction of the base section 30, the swing amplitude of the second nozzle segment 20 is reduced. The edge of the second air inlet 21 of the second nozzle segment 20 hitting the limiting ring 70 sleeved to the first nozzle segment 10 is defined as the maximum swing amplitude of the second nozzle segment 20. At the same time, the limiting ring 70 may prevent the edge of the second air inlet 21 of the second nozzle segment 20 from hitting the first nozzle segment 10. The limiting ring 70 may be sleeved to an adjoiner of the second opening of the at least one second nozzle segment of the M second nozzle segments 20. When the limiting ring 70 moves forward (not shown) according to the wind direction of the base section 30, the swing amplitude of the next second nozzle segment 20 is increased. When the limiting ring 70 moves backward (not shown) according to the wind direction of the base section 30, the swing amplitude of the next second nozzle segment 20 is reduced. The edge of the second air inlet 21 of the next second nozzle segment 20 hitting the limiting ring 70 sleeved to the second nozzle segment 20 is defined as the maximum swing amplitude of the next second nozzle segment 20. At the same time, the limiting ring 70 may prevent the edge of the second air inlet 21 of the next second nozzle segment 20 from hitting the second nozzle segment 20.

In the second embodiment, the multi-segment nozzle 100 of the disclosure further includes a limiting mechanism 60 for accommodating at least one of the first nozzle segment 10 and the at least one second nozzle segment 20. The limiting mechanism 60 includes at least one pair of a first limiting member 61 and a second limiting member 62. The first limiting member 61 and the second limiting member 62 are relatively disposed on two sides of at least one of the first nozzle segment 10 and the at least one second nozzle segment 20. When the first limiting member 61 and the second limiting member 62 move outward according to the perpendicular wind direction of the base section 30, the swing amplitudes of the first nozzle segment 10 and the at least one second nozzle segment 20 are adjusted to be increased and the swing frequencies thereof are slower. When the first limiting member 61 and the second limiting member 62 move inward according to the perpendicular wind direction of the base section 30, the swing amplitudes of the first nozzle segment 10 and the at least one second nozzle segment 20 are adjusted to be reduced and the swing frequencies thereof are faster. The edge of the first air inlet 11 of the first nozzle segment 10 hitting the limiting ring 70 sleeved to the base section 30 is defined as the maximum swing amplitude of the first nozzle segment 10. The edge of the second air inlet 21 of the second nozzle segment 20 hitting the limiting ring 70 sleeved to the first nozzle segment 10 is defined as the maximum swing amplitude of the second nozzle segment 20. When the first limiting member 61 and the second limiting member 62 move forward (not shown) according to the wind direction of the base section 30, the swing frequencies of the first nozzle segment 10 and the at least one second nozzle segment 20 are slower. When the first limiting member 61 and the second limiting member 62 move backward (not shown) according to the wind direction of the base section 30, the swing frequencies of the first nozzle segment 10 and the at least one second nozzle segment 20 are faster. The materials of the first limiting member 61 and the second limiting member 62 are mainly heat-resistant silicone in order to reduce material wear and increase rebound swing force. The limiting mechanism 60 may manually or automatically change the movement positions of the first limiting member 61 and the second limiting member 62.

In the second embodiment, the multi-segment nozzle 100 of the disclosure further includes a rotating mechanism 90. The rotating mechanism 90 is, for example, a rotating gear set. The rotating mechanism 90 is connected to the base section 30. The rotating mechanism 90 may be manually or automatically rotated, so that the base section 30 rotates according to the wind direction of the base section 30, which may effectively control the rotational angle, direction, and speed. The multi-segment nozzle 100 further includes a rotating device 80. The rotating device 80 may be, for example, a motor that provides rotational power to drive the rotating gear set to rotate. However, the rotating driving method of the disclosure is not limited to the use of the motor and the rotating gear set. The rotating mechanism 90 may be a rotating gear set, a chain set, or a heat-resistant pulley set. The heat-resistant pulley set is preferred for vibrational noise reduction.

In the third embodiment of the disclosure, please combine the descriptions with reference to FIG. 1, FIG. 2, FIG. 3, FIG. 4, FIG. 5, and FIG. 6. FIG. 6 is a schematic view of a cooking oven 200. The cooking oven 200 of the disclosure includes the following. A chamber 210 is configured to accommodate a food 230. A hot wind module 220 includes a heat generating element 222 and a wind speed generating element 221. A multi-segment nozzle 100 according to the first embodiment or the second embodiment. Heat energy provided by the heat generating element 222 generates wind pressure of airflow via the wind speed generating element 221 and is output to the airflow outlet 211, and is brought to the second nozzle segment 20 via the base section 30 and the first nozzle segment 10 of the multi-segment nozzle 100 according to the first embodiment or the second embodiment. By swing inertia of the first rotating shaft assembly 40 of the first nozzle segment 10 and the second rotating shaft assembly 50 of the second nozzle segment 20, a periodically swinging jet airflow (not shown) is generated in the chamber. The multi-segment nozzle 100 according to the first embodiment or the second embodiment continuously impacts the jet airflow (not shown) onto the food 230. The multi-segment nozzle 100 according to the first embodiment or the second embodiment may be disposed on the top surface in the chamber. The third opening 32 of the base section 30 of the multi-segment nozzle 100 according to the first embodiment or the second embodiment may be connected to the chamber 210 of the cooking oven 200 or may also be detachable. The heat generating element 222 is an electric current heating element that can generate heat radiation or heat convection, such as an electric heating tube, a quartz heating tube, or an electric heating wire. The wind speed generating element 221 is, for example, a blast pump, an air compressor, a motor, or a fan.

At the same time, continue to refer to the third embodiment shown in FIG. 5 and FIG. 6. In this embodiment, the cooking oven 200 of the disclosure further includes the rotating mechanism 90 connected to the base section 30 of the multi-segment nozzle 100 according to the first embodiment or the second embodiment. When the rotating mechanism 90 may be manually or automatically driven to rotate, the base section 30 will rotate according to the wind direction of the base section, which may effectively control the rotational angle, direction, and speed. The rotating mechanism 90 may be, for example, a rotating gear set, a chain set, or a heat-resistant pulley set, and the heat-resistant pulley set is preferred for vibrational noise reduction, but the disclosure is not limited thereto. The rotating mechanism 90 may further include the rotating device 80 that provides rotational power. The rotating mechanism 90 is driven to rotate by the rotating device 80. The rotating device 80 may be, for example, a motor. However, the rotating device 80 of the disclosure is not limited to the use of the motor.

Finally, it is emphasized that the scope of the multi-segment nozzle 100 and the cooking oven 200 of the disclosure includes, but is not limited to, the embodiments exemplified here. The constituent elements and steps of the foregoing embodiments of the disclosure are only for exemplification and are not used to limit the scope of the disclosure. The substitution or change of other equivalent elements and steps should also be covered by the scope of the claims of the disclosure.

What is claimed is:

1. A multi-segment nozzle, with one end connected to an airflow outlet in a chamber, comprising:
a first nozzle segment, being a hollow shell, wherein two sides of the hollow shell respectively have a first air inlet and a first opening communicated with an inside of the hollow shell, an inner diameter of the hollow shell gradually decreases from the first air inlet to the first opening;
a second nozzle segment, being a hollow shell, wherein two sides of the hollow shell respectively have a second air inlet and a second opening communicated with an inside of the hollow shell, an inner diameter of the hollow shell gradually decreases from the second air inlet to the second opening, and an inner diameter of the second air inlet of the second nozzle segment is greater than an inner diameter of the first opening of the first nozzle segment;
a base section, being a hollow shell, wherein two sides of the hollow shell respectively have a third air inlet and a third opening communicated with an inside of the hollow shell, and the third air inlet of the base section is communicated with the airflow outlet;
a first rotating shaft assembly, pivotally connected at a junction of the first air inlet of the first nozzle segment and the third opening of the base section, so that the first nozzle segment may swing; and
a second rotating shaft assembly, pivotally connected at a junction of the second air inlet of the second nozzle segment and the first opening of the first nozzle segment, so that the second nozzle segment may swing.

2. The multi-segment nozzle according to claim 1, wherein initially, when the second nozzle segment yaws clockwise according to the second rotating shaft assembly, the first nozzle segment is driven by the second nozzle segment to yaw counterclockwise according to the first rotating shaft assembly, and when the first nozzle segment is changed to yawing clockwise by wind pressure, the second nozzle segment is changed to yawing counterclockwise according to the second rotating shaft assembly; and after continuous operation, due to simultaneous action of the wind pressure and swing inertia, the first nozzle segment and the second nozzle segment yaw in a same direction.

3. The multi-segment nozzle according to claim 1, further comprising at least one limiting ring, wherein the limiting ring is sleeved to an adjoiner of the third opening of the base section or the limiting ring is sleeved to an adjoiner of the first opening of the first nozzle segment.

4. The multi-segment nozzle according to claim 1, further comprising a limiting mechanism for accommodating at least one of the first nozzle segment and the second nozzle segment, wherein the limiting mechanism comprises at least one pair of a first limiting member and a second limiting member, the first limiting member and the second limiting member are relatively disposed on two sides of at least one of the first nozzle segment and the second nozzle segment, and when the first limiting member and the second limiting member moves outward or inward according to a perpendicular wind direction of the base section, swing amplitudes or frequencies of the first nozzle segment and the second nozzle segment are adjusted.

5. The multi-segment nozzle according to claim 1, wherein initially, at least one of the first nozzle segment and the second nozzle segment is arranged at an oblique angle with respect to a wind direction of the base section, and when wind pressure generated by the airflow outlet is brought to the second nozzle segment via the first nozzle segment, by action of the wind pressure and swing inertia, the first nozzle segment and the second nozzle segment respectively generate a periodic swing with respect to the first rotating shaft assembly and the second rotating shaft assembly.

6. The multi-segment nozzle according to claim 1, wherein the first rotating shaft assembly comprises two rotating shafts parallel to each other and the second rotating shaft assembly comprises two rotating shafts parallel to each other.

7. The multi-segment nozzle according to claim 1, further comprising a rotating mechanism connected to the base section, wherein when the rotating mechanism is driven to rotate, the base section rotates according to a wind direction of the base section.

8. A multi-segment nozzle, with one end connected to an airflow outlet in a chamber, comprising:
a first nozzle segment, being a hollow shell, wherein two sides of the hollow shell respectively have a first air inlet and a first opening communicated with an inside of the hollow shell, an inner diameter of the hollow shell gradually decreases from the first air inlet to the first opening;
M second nozzle segments, where M is a positive integer greater than or equal to 2, wherein each of the M second nozzle segments is a hollow shell, two sides of the hollow shell respectively have a second air inlet and a second opening communicated with an inside of the hollow shell, an inner diameter of the hollow shell gradually decreases from the second air inlet to the second opening, and an inner diameter of the second air inlet of the second nozzle segment is greater than an inner diameter of the first opening of the first nozzle segment;
a base section, being a hollow shell, wherein two sides of the hollow shell respectively have a third air inlet and a third opening communicated with an inside of the hollow shell, and the third air inlet of the base section is communicated with the airflow outlet;
a first rotating shaft assembly, pivotally connected at a junction of the first air inlet of the first nozzle segment and the third opening of the base section, so that the first nozzle segment may swing; and
M second rotating shaft assemblies, where M is a positive integer greater than or equal to 2, corresponding one-to-one to the M second nozzle segments, wherein the M second nozzle segments are serially connected back and forth in sequence by the M second rotating shaft assemblies, wherein the first second rotating shaft assembly is pivotally connected at a junction disposed at the second air inlet of the corresponding second nozzle segment positioned first and the first opening of the first nozzle segment, and each of remaining second rotating shaft assemblies is pivotally connected at a junction of the second opening of the second nozzle segment positioned in front and the second air inlet of the second nozzle segment positioned behind, so that each of the M second nozzle segments may swing.

9. The multi-segment nozzle according to claim 8, wherein the first rotating shaft assembly comprises two rotating shafts parallel to each other and the second rotating shaft assembly comprises two rotating shafts parallel to each other.

10. The multi-segment nozzle according to claim 8, further comprising at least one limiting ring, wherein the limiting ring is sleeved to an adjoiner of the third opening of the base section, the limiting ring is sleeved to an adjoiner of the first opening of the first nozzle segment, or the limiting ring is sleeved to an adjoiner of the second opening of the at least one second nozzle segment of the M second nozzle segments.

11. The multi-segment nozzle according to claim 8, further comprising a limiting mechanism for accommodating at least one of the first nozzle segment and the at least one second nozzle segment, the limiting mechanism comprises at least one pair of a first limiting member and a second limiting member, the first limiting member and the second limiting member are relatively disposed on two sides of the at least one of the first nozzle segment and the at least one second nozzle segment, and when the first limiting member and the second limiting member move outward or inward according to a perpendicular wind direction of the base section, swing amplitudes or frequencies of the first nozzle segment and the at least one second nozzle segment are adjusted.

12. The multi-segment nozzle according to claim 8, further comprising a rotating mechanism connected to the base section, wherein when the rotating mechanism is driven to rotate, the base section rotates according to a wind direction of the base section.

13. The multi-segment nozzle according to claim 8, wherein initially, when the second nozzle segment positioned first yaws clockwise according to the second rotating shaft assembly, the first nozzle segment is driven by the second nozzle segment positioned first to yaw counterclockwise according to the first rotating shaft assembly, and when the first nozzle segment is changed to yawing clockwise by wind pressure, the second nozzle segment positioned first is changed to yawing counterclockwise according to the second rotating shaft assembly; when any one of the remaining second nozzle segments yaws clockwise according to the second rotating shaft assembly, the second nozzle segment positioned in front is driven by the second nozzle segment to be changed to yawing counterclockwise according to the second rotating shaft assembly corresponding to the second nozzle segment positioned in front, and when the second nozzle segment positioned in front is changed to yawing clockwise by the wind pressure according to the second rotating shaft assembly, the second nozzle segment is changed to yawing counterclockwise according to the corresponding second rotating shaft assembly; and after continuous operation, due to simultaneous action of the wind pressure and swing inertia, the first nozzle segment and the second nozzle segment yaw in a same direction.

14. The multi-segment nozzle according to claim 8, wherein initially, at least one of the first nozzle segment and the M second nozzle segments is arranged at an oblique angle with respect to a wind direction of the base section, wind pressure generated by the airflow outlet is brought to the M second nozzle segments via the first nozzle segment, by action of the wind pressure and swing inertia, the first nozzle segment and the M second nozzle segments respectively generate a periodic swing with respect to the first rotating shaft assembly and the M second rotating shaft assemblies, and the larger a value of M, the larger swing amplitudes of the first nozzle segment and the M second nozzle segments.

15. A cooking oven, comprising:
a chamber, configured to accommodate a food;
a hot wind module, comprising a heat generating element and a wind speed generating element; and
a multi-segment nozzle, wherein
one end of the multi-segment nozzle is connected with an airflow outlet in the chamber, and the multi-segment nozzle comprises a first nozzle segment, being a hollow shell, wherein two sides of the hollow shell respectively have a first air inlet and a first opening communicated with an inside of the hollow shell, an inner diameter of the hollow shell gradually decreases from the first air inlet to the first opening; a second nozzle segment, being a hollow shell, wherein two sides of the hollow shell respectively have a second air inlet and a second opening communicated with an inside of the hollow shell, an inner diameter of the hollow shell gradually decreases from the second air inlet to the second opening, and an inner diameter of the second air inlet of the second nozzle segment is greater than an inner diameter of the first opening of the first nozzle segment; a base section, being a hollow shell, wherein two sides of the hollow shell respectively have a third air inlet and a third opening communicated with an inside of the hollow shell, and the third air inlet of the base section is communicated with the airflow outlet; a first rotating shaft assembly, pivotally connected at a junction of the first air inlet of the first nozzle segment and the third opening of the base section, so that the first nozzle segment may swing; and a second rotating shaft assembly, pivotally connected at a junction of the second air inlet of the second nozzle segment and the first opening of the first nozzle segment, so that the second nozzle segment may swing; the multi-segment nozzle is disposed on a top surface in the chamber, heat energy provided by the heat generating element generates wind pressure of airflow via the wind speed generating element and is output to the airflow outlet, and is brought to the second nozzle segment via the base section and the first nozzle segment of the multi-segment nozzle, by swing inertia of the first rotating shaft assembly of the first nozzle segment and the second rotating shaft assembly of the second nozzle segment, a periodically swinging jet airflow is generated in the chamber, and the multi-segment nozzle continuously impacts the jet airflow onto the food.

16. The cooking oven according to claim 15, further comprising a rotating mechanism connected to the base section, wherein when the rotating mechanism is driven to rotate, the base section rotates according to a wind direction of the base section.

17. A cooking oven, comprising:
a chamber, configured to accommodate a food;
a hot wind module, comprising a heat generating element and a wind speed generating element; and
a multi-segment nozzle, wherein
one end of the multi-segment nozzle is connected with an airflow outlet in the chamber, and the multi-segment nozzle comprises a first nozzle segment, being a hollow shell, wherein two sides of the hollow shell respectively have a first air inlet and a first opening communicated with an inside of the hollow shell, an inner diameter of the hollow shell gradually decreases from the first air inlet to the first opening; M second nozzle segments, where M is a positive integer greater than or equal to 2, wherein each of the M second nozzle segments is a hollow shell, two sides of the hollow shell respectively have a second air inlet and a second opening communicated with an inside of the hollow shell, an inner diameter of the hollow shell gradually decreases from the second air inlet to the second opening, and an inner diameter of the second air inlet of the second nozzle segment is greater than an inner diameter of the first opening of the first nozzle segment; a base section, being a hollow shell, wherein two sides of the hollow shell respectively have a third air inlet and a third opening communicated with an inside of the hollow shell, and the third air inlet of the base section is communicated with the airflow outlet; a first rotating shaft assembly, pivotally connected at a junction of the first air inlet of the first nozzle segment and the third opening of the base section, so that the first nozzle segment may swing;
and M second rotating shaft assemblies, where M is a positive integer greater than or equal to 2, corresponding one-to-one to the M second nozzle segments, wherein the M second nozzle segments are serially connected back and forth in sequence by the M second rotating shaft assemblies, wherein the first second rotating shaft assembly is pivotally connected at a junction disposed at the second air inlet of the corresponding second nozzle segment positioned first and the first opening of the first nozzle segment, and each of remaining second rotating shaft assemblies is pivotally connected at a junction of the second opening of the second nozzle segment positioned in front and the second air inlet of the second nozzle segment positioned behind, so that each of the M second nozzle segments may swing;
the multi-segment nozzle is arranged on a top surface in the chamber, heat energy provided by the heat generating element generates wind pressure of airflow via the wind speed generating element and is output to the airflow outlet, and is brought to the second nozzle segment via the base section and the first nozzle segment of the multi-segment nozzle, by swing inertia of the first rotating shaft assembly of the first nozzle segment and the second rotating shaft assembly of the second nozzle segment, a periodically swinging jet airflow is generated in the chamber, and the multi-segment nozzle continuously impacts the jet airflow onto the food.

18. The cooking oven according to claim 17, further comprising a rotating mechanism connected to the base section, wherein when the rotating mechanism is driven to rotate, the base section rotates according to a wind direction of the base section.
